(19) United States
(12) Patent Application Publication
(10) Pub. No.: US 2017/0015184 A1
(43) Pub. Date: Jan. 19, 2017

(54) WEATHERSTRIP FOR SUNROOF APPARATUS

(71) Applicant: AISIN SEIKI KABUSHIKI KAISHA, Kariya-shi (JP)

(72) Inventor: Kazuki SAWADA, Wuxi (CN)

(73) Assignee: AISIN SEIKI KABUSHIKI KAISHA, Kariya-shi (JP)

(21) Appl. No.: 15/208,745

(22) Filed: Jul. 13, 2016

(30) Foreign Application Priority Data
Jul. 15, 2015 (JP) 2015-141442

(51) Int. Cl. B60J 10/90; B60J 7/02; B60J 10/32

(52) U.S. Cl. CPC B60J 10/90; B60J 10/32; B60J 7/02

(57) ABSTRACT

A weatherstrip for a sunroof apparatus includes: an attachment portion attached to a support portion provided in a roof in such a way as to be aligned with a gap between an opening formed in the roof and a roof panel blocking the opening, and in which a drain is disposed closer to an opposite center side of the opening than the support portion; a first seal portion connected to the attachment portion, and in liquid-tight contact with a panel end edge of the panel; a second upper seal portion connected to an upper end of the attachment portion in a cantilever manner, and in liquid-tight contact with an opening end edge of the opening; and a second lower seal portion positioned lower than the second upper seal portion, connected to the attachment portion in a cantilever manner, and extending further from the support portion toward the opposite center.

### CROSS REFERENCE TO RELATED APPLICATIONS

This application is based on and claims priority under 35 U.S.C. §119 to Japanese Patent Application 2015-141442, filed on Jul. 15, 2015, the entire contents of which are incorporated herein by reference.

### TECHNICAL FIELD

This disclosure relates to a weatherstrip for a sunroof apparatus.

### BACKGROUND DISCUSSION

A weatherstrip for a sunroof apparatus in the related art is disclosed in U.S. Patent Application Publication No. 2007/228779 (refer to FIG. 5) (Reference 1). As illustrated in FIG. 4, a weatherstrip 95 is mounted on a roof 90 while extending along an edge portion of an opening 91 formed in the roof 90 of a vehicle. That is, a support portion 93 is provided in the roof 90 in a standing manner so as to be aligned with a gap C90 between the opening 91 and a movable panel 92 which has blocked the opening 91. The weatherstrip 95 includes an attachment portion 96 molded to have a substantially L-shaped cross-section following the exterior of the support portion 93. The weatherstrip 95 is mounted on the roof 90 in such a way that the attachment portion 96 is joined to the support portion 93.

The weatherstrip 95 includes a first seal portion 97 having a substantially bow-shaped cross-section, both ends of which are connected to the attachment portion 96. The first seal portion 97 is in liquid-tight contact with a flange-shaped panel end edge 92a of the movable panel 92 which has blocked the opening 91. The first seal portion 97 and the attachment portion 96 collaboratively form a hollow cross-section. The weatherstrip 95 includes a second seal portion 98 having a substantially lip-shaped cross-section which is connected to an upper end of the attachment portion 96 in a cantilever manner. The second seal portion 98 is in liquid-tight contact with a flange-shaped opening end edge 98a of the opening 91. As a result, the weatherstrip 95 prevents the infiltration of water drops, rain drops, or the like through the gap C90.

In the weatherstrip 95 disclosed in Reference 1, the second seal portion 98 is connected to the upper end of the attachment portion 96 in a cantilever manner, and thus, during high-pressure vehicle wash, high-pressure water may elastically deform the second seal portion 98, and infiltrate into an area below the second seal portion 98. Typically, a drain is installed in an area below the second seal portion 98 so as to cope with the infiltration of water. If high-pressure water reaches the drain, the high-pressure water may randomly rebound from the drain, and leak from the drain.

### SUMMARY

Thus, a need exists for a weatherstrip which is not suspectable to the drawback mentioned above.

A weatherstrip for a sunroof apparatus according to an aspect of this disclosure includes: an attachment portion that is attached to a support portion which is provided in a roof of a vehicle in such a way as to be aligned with a gap between an opening formed in the roof and a roof panel blocking the opening, and in which a drain is disposed closer to an opposite center side of the opening than the support portion; a first seal portion that is connected to the attachment portion, and is in liquid-tight contact with a panel end edge of the roof panel; a second upper seal portion that is connected to an upper end of the attachment portion in a cantilever manner, and is in liquid-tight contact with an opening end edge of the opening; and a second lower seal portion that is positioned lower than the second upper seal portion, is connected to the attachment portion in a cantilever manner, and extends further from the support portion toward the opposite center side of the opening.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exploded perspective view illustrating a roof to which a weatherstrip for a sunroof apparatus of an embodiment is applied;

FIGS. 2A and 2B are sectional views taken along lines 2A-2A and 2B-2B in FIG. 1;

FIG. 3 is a sectional view illustrating a molded form of a first seal portion of a corner portion; and

FIG. 4 is a sectional view illustrating the structure of a weatherstrip for a sunroof apparatus in the related art.

### DETAILED DESCRIPTION

Hereinafter, an embodiment of a weatherstrip for a sunroof apparatus will be described. Hereinafter, a “forward and rearward direction” refers to a forward and rearward direction of a vehicle. An “upper side” and a “lower side” respectively refer to an upper side and a lower side of the vehicle in a vertical direction of the vehicle.

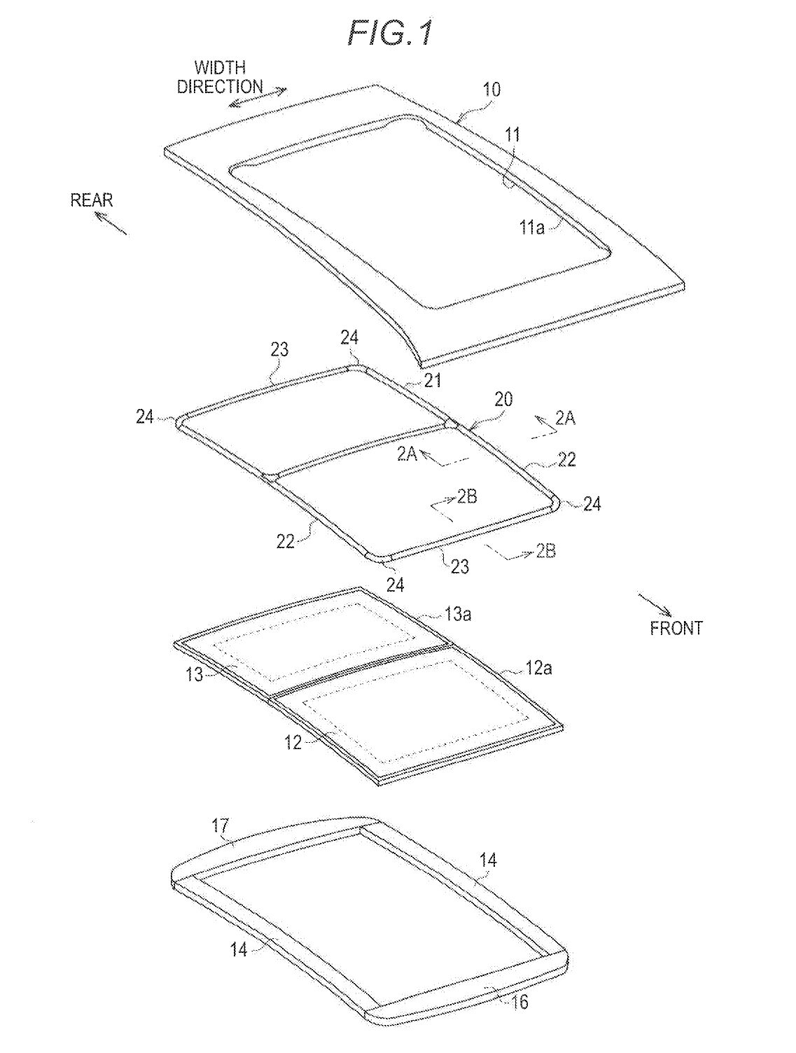

As illustrated in FIG. 1, a substantially rectangular opening 11 is formed in a roof 10 of a vehicle such as an automobile. The opening 11 includes an opening end edge 11a having the shape of a substantially rectangular tube which extends downward over substantially the entire circumference of the opening 11. In the roof 10, a substantially rectangular movable panel 12 made of a glass plate or the like and a fixed panel 13 are provided in a row in the forward and rearward direction. The movable panel 12 and the fixed panel 13 form a roof panel.

The movable panel 12 is attached in such a way as to be capable of opening and closing a front portion of the opening 11. That is, the movable panel 12 is attached such that the movable panel 12 can be tilted upward, specifically, a rear portion of the movable panel 12 moves upward around a front portion of the movable panel 12, or the movable panel 12 can be slid in the forward and rearward direction. The movable panel 12 is slid while being kept in a tilt-up state when opening and closing the front portion of the opening 11, that is, a so-called outer sliding type is adopted. The movable panel 12 includes a panel end edge 12a having the shape of a substantially rectangular tube which extends downward over substantially the entire circumference of the movable panel 12.

In contrast, the fixed panel 13 is attached such that the fixed portion 13 normally closes a rear portion of the opening 11. The fixed panel 13 includes a panel end edge 13a having the shape of a substantially rectangular tube which extends downward over substantially the entire circumference of the fixed panel 13.

A pair of guide rails 14 are respectively installed in the roof 10 such that the pair of guide rails 14 extend along both edge portions of the opening 11 in a width direction of the vehicle, and extend along the edge portions of the opening 11 in the forward and rearward direction. A front housing 16 is installed in the roof 10 such that the front housing 16 extends along a front edge portion of the opening 11 in the width direction of the vehicle, and front ends of both the guide rails 14 are connected to each other via the front housing 16. A rear housing 17 is installed in the roof 10 such that the rear housing 17 extends along a rear edge portion of the opening 11 in the width direction of the vehicle, and rear ends of both the guide rails 14 are connected to each other via the rear housing 17. Each of the guide rails 14 is made of an extruded aluminum alloy or the like. The front housing 16 and the rear housing 17 are made of resin.

A pair of functional components (not illustrated) are respectively supported by both the guide rails 14 such that the functional components are capable of moving in the forward and rearward direction. The movable panel 12 is linked to and supported by both the functional components in a state where the movable panel 12 is bridged therebetween. As both the functional components move in the forward and rearward direction, the movable panel 12 opens and closes the opening 11.

In addition, a weatherstrip 20 is mounted on the roof 10. The weatherstrip 20 includes a weatherstrip body 21 having a substantially rectangular annular shape which is mounted along a circumferential edge portion of the opening 11. The weatherstrip body 21 includes a pair of side weatherstrips 22 that extend in the forward and rearward direction along both the edge portions of the opening 11 in the width direction, and a pair of front and rear weatherstrips 23 that extend in the width direction along both edge portions of the opening 11 in the forward and rearward direction. A front end and a rear end of each of the side weatherstrips 22 are respectively connected to tip ends of the pair of front and rear weatherstrips 23 via die-molded corner portions 24. Each of both the side weatherstrips 22 and both the front and rear weatherstrips 23 is made of the same type of an extruded material having a substantially uniform cross-section in an extension direction of the extruded material.

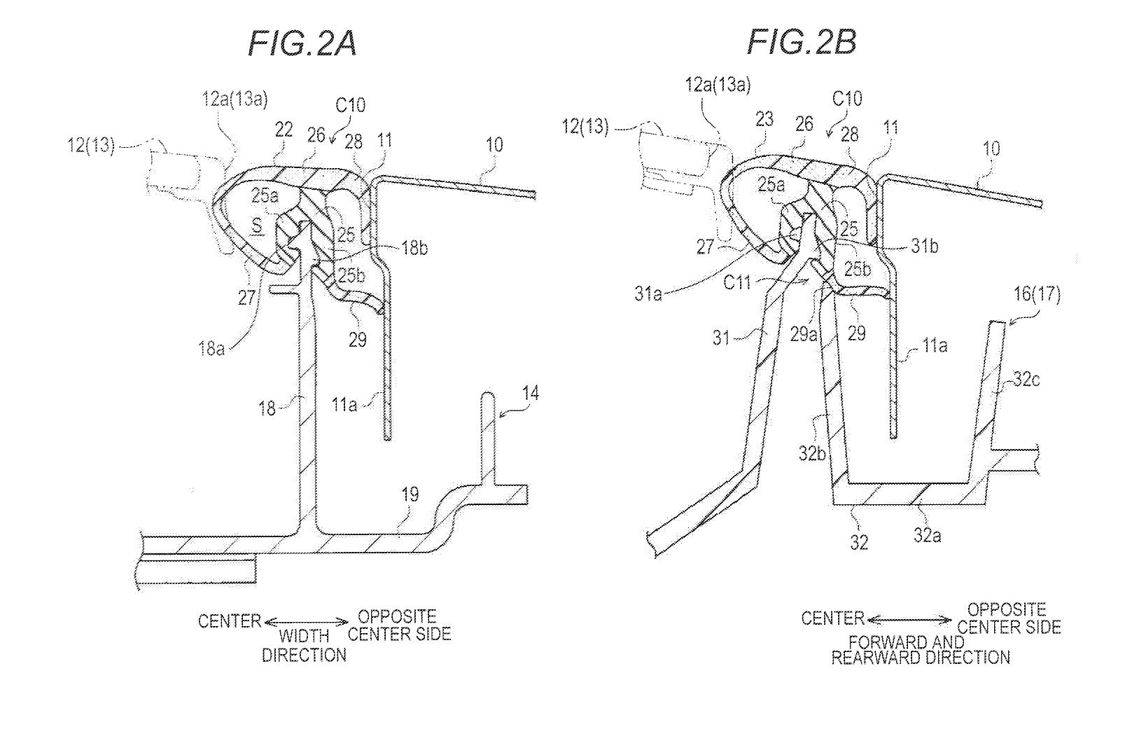

As illustrated in FIG. 2A, each of the side weatherstrips 22 is attached to the guide rail 14, and seals a gap between the opening end edge 11a of the opening 11 and the panel end edge 12a (or 13a) of the movable panel 12 (or fixed panel 13), which has blocked the opening 11, on each side in the width direction. That is, a support portion 18 having a substantially vertical wall shape is provided on each of the guide rails 14 in a standing manner so as to be aligned with a gap C10 between the opening 11 and the movable panel 12 which has blocked the opening 11. The guide rail 14 and the support portion 18 form a rail side drain 19 on an opposite center side of the support portion 18. The rail side drain 19 is a substantially U-shaped groove, and runs in the forward and rearward direction. The rail side drain 19 is positioned across the opening end edge 11a in the width direction of the vehicle.

The side weatherstrip 22 includes an attachment portion 25 which is made of an extruded solid material such as synthetic rubber (for example, EPDM) or thermoplastic elastomer, and which extends over substantially the entire length of the guide rail 14 in the forward and rearward direction. The attachment portion 25 includes a pair of leg portions 25a and 25b which are respectively disposed on a center side (hereinafter, simply referred to as a “center side”) and an opposite center side (hereinafter, simply referred to as an “opposite center side”) of the opening 11. The attachment portion 25 is molded to have a substantially U-shaped cross-section, and to open downward. The attachment portion 25 is attached to the roof 10 in a state where the support portion 18 provided on the guide rail 14 in a standing manner is inserted between both the leg portions 25a and 25b. The support portion 18 includes a first protrusion portion 18a on the center side of the opening 11, and a second protrusion portion 18b on the opposite center side of the opening 11. The leg portion 25a is engaged with the first protrusion portion 18a, and the leg portion 25b is engaged with the second protrusion portion 18b.

The side weatherstrip 22 includes a seal portion 26 which is an extruded sponge material such as synthetic rubber (for example, EPDM) or thermoplastic elastomer, and which is connected to an upper end of the attachment portion 25. The seal portion 26 includes a first seal portion 27 that protrudes from the attachment portion 25 toward the movable panel 12 and the fixed panel 13, that is, toward the center side while being curved. Both ends of the first seal portion 27 are respectively the upper end of the attachment portion 25 and a lower end of the leg portion 25a such that a space S is formed between the first seal portion 27 and the attachment portion 25. The first seal portion 27 is molded to have a substantially bow-shaped cross-section, and to protrude toward the center side in a free state. The first seal portion 27 and the attachment portion 25 collaboratively form a substantially D-shaped hollow cross-section. The first seal portion 27 is elastically deformed in such a way as to overlap a portion of the panel end edge 12a (13a) in the vertical direction of the vehicle, and is in liquid-tight contact therewith.

The seal portion 26 includes a second upper seal portion 28 which protrudes from the attachment portion 25 toward the opening 11, that is, the opposite center side, and which is in liquid-tight contact with the opening end edge 11a. The second upper seal portion 28 is connected to the upper end of the attachment portion 25 while one end of the second upper seal portion 28 is kept as a free end.

The side weatherstrip 22 includes a second lower seal portion 29 which is made of an extruded sponge material such as synthetic rubber (for example, EPDM) or thermoplastic elastomer, and which is connected to a lower end of the leg portion 25b. The second lower seal portion 29 extends on an extension line of a protrusion direction of the second protrusion portion 18b, and is connected to the lower end of the leg portion 25b while one end of the second lower seal portion 29 is kept as a free end. The second lower seal portion 29 protrudes toward the opening 11, that is, toward the opposite center side, and is in liquid-tight contact with the opening end edge 11a. Naturally, the second lower seal portion 29 is positioned lower than the second upper seal portion 28, and is positioned higher than the rail side drain (bottom wall) 19.

As illustrated in FIG. 2B, the front and rear weatherstrip 23 is attached to the front housing 16 (or rear housing 17), and seals a gap between the opening end edge 11a of the opening 11 and the panel end edge 12a (or 13a) of the movable panel 12 (or fixed panel 13), which has blocked the opening 11, on each side in the forward and rearward direction. That is, a support portion 31 having a substantially vertical wall shape is provided on the front housing 16 in a standing manner so as to be aligned with the gap C10 between the opening 11 and the movable panel 12 which has blocked the opening 11. The front housing 16 includes a housing side drain 32 formed on an opposite center side of the support portion 31. The housing side drain 32 includes a substantially long bottom wall 32a extending in the width direction, and a pair of side walls 32b and 32c which are respectively provided at a center side end and an opposite center side end of the bottom wall 32a in a standing manner. The housing side drain 32 has the shape of a substantially U-shaped groove which runs in the width direction. The housing side drain 32 is positioned across the opening end edge 11a in the forward and rearward direction. The one (center side) side wall 32b of the housing side drain 32 is disposed lower than the leg portion 25b (attachment portion 25). A molding gap C11 is formed between the side wall 32b (housing side drain 32) and the support portion 31 in the forward and rearward direction. The reason for this is to omit a mold slide mechanism when the front housing 16 is resin-molded.

Similar to the side weatherstrip 22, the front and rear weatherstrip 23 includes the attachment portion 25; the seal portion 26 (first seal portion 27 and second upper seal portion 28); and the second lower seal portion 29. The attachment portion 25 of the front and rear weatherstrip 23 extends over substantially the entire length of the front housing 16 in the width direction. The front and rear weatherstrip 23 is attached to the roof 10 in a state where the support portion 31 is inserted between both the leg portions 25a and 25b. The support portion 31 includes a first protrusion portion 31a on the center side of the opening 11, and a second protrusion portion 31b on the opposite center side of the opening 11. The leg portion 25a is engaged with the first protrusion portion 31a, and the leg portion 25b is engaged with the second protrusion portion 31b. The seal portion 26 of the front and rear weatherstrip 23 has the same function as that of the seal portion 26 of the side weatherstrip 22. The second lower seal portion 29 of the front and rear weatherstrip 23 extends on an extension line of a protrusion direction of the second protrusion portion 31b, and has the same function as that of the second lower seal portion 29 of the side weatherstrip 22. In contrast, the second lower seal portion 29 protrudes toward the opening 11, that is, toward the opposite center side in a state where a base end portion 29a of the second lower seal portion 29 positioned at the lower end of the leg portion 26b is in liquid-tight contact with an upper end of the one (center side) side wall 32b. Naturally, the second lower seal portion 29 is positioned higher than the housing side drain 32 (bottom wall 32a). As a result, the infiltration of water from the housing side drain 32 into an attachment portion 25 side (molding gap C11) is prevented.

A rear one of the front and rear weatherstrips 23 is the same as a front one of the front and rear weatherstrips 23 except that the movable panel 12 (panel end edge 12a) which blocks the opening 11 is replaced with the fixed panel 13 (panel end edge 13a), and the front housing 16 is replaced with the rear housing 17.

Each of the die-molded corner portion 24 includes the same attachment portion 25, the same seal portion 26 (first seal portion 27 and second upper seal portion 28), and the second lower seal portion 29 such that a seal function is not lost in a connection portion between the side weatherstrip 22 and the front and rear weatherstrip 23. In other words, both end portions of the support portion 31 in the width direction of the vehicle, to which the attachment portion 25 is attached, are curved following the curvature of the corner portion 24 such that the support portion 31 is substantially continuous with the support portion 18 of the guide rail 14.

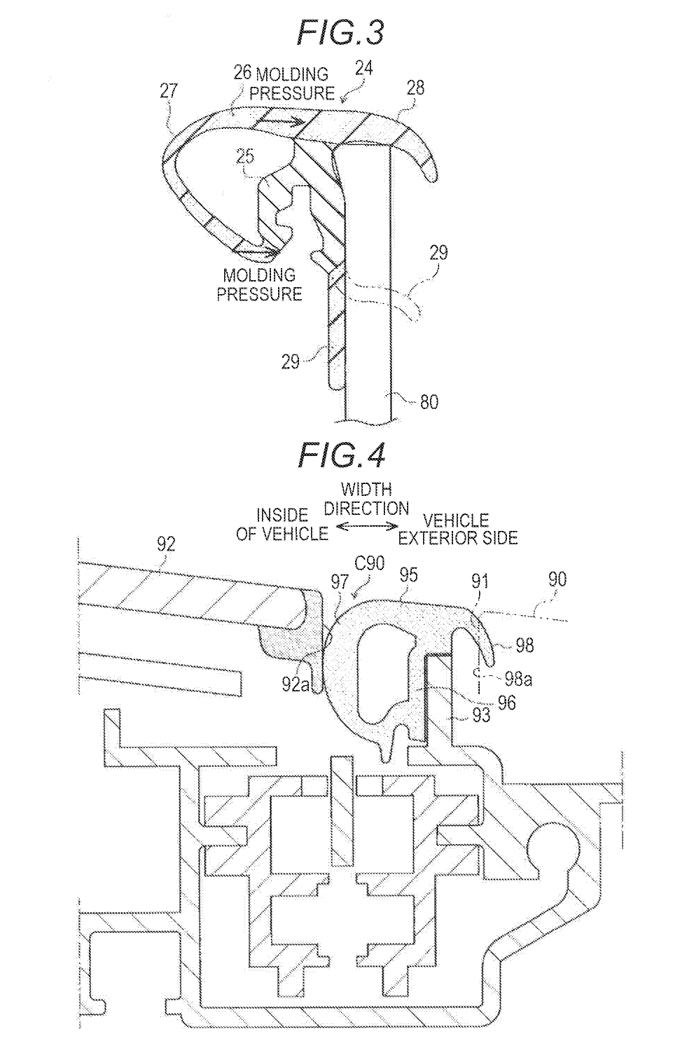

As illustrated in FIG. 3, when the corner portion 24 is die-molded, it is necessary to dispose a die 80 along a surface of the attachment portion 25 which is opposite to (on a second upper seal portion 28 side) the first seal portion 27, such that the die 80 receives molding pressure generated during the molding of the first seal portion 27. Since both the second upper seal portion 28 and the second lower seal portion 29 are connected to the attachment portion 25 in a cantilever manner, the die 80 is allowed to be disposed in the aforementioned manner via elastic deformation of the second upper seal portion 28 and the second lower seal portion 29. In other words, it is not necessary to provide a cavity insert in the die, or to provide a hole for the insertion of the cavity insert in the second upper seal portion 28.

As described above, according to the embodiment, it is possible to obtain the following operational effects.

(1) In the embodiment, the first seal portion 27 and the second upper seal portion 28 are capable of collaboratively preventing the infiltration of water through the gap C10 between the opening 11 (opening end edge 11a) and the movable panel 12 (panel end edge 12a) which has blocked the opening 11, and between the opening 11 and the fixed panel 13 (panel end edge 13a). Particularly, since the second lower seal portion 29 is positioned lower than the second upper seal portion 28, during high-pressure vehicle wash, if high-pressure water elastically deforms the second upper seal portion 28, and infiltrates into an area below the second upper seal portion 28, the high-pressure water elastically deforms the second lower seal portion 29 as well. For this reason, downward force of high-pressure water is reduced due to elastic deformation of the second lower seal portion 29 or elastic restoring associated with the elastic deformation, or downward force is dispersed in movement directions, Therefore, even if high-pressure water reaches the rail side drain 19 or the housing side drain 32, it is possible to prevent the infiltration of water through the drain 19 or 32.

(2) In the embodiment, since the base end portion 29a of the second lower seal portion 29 of the front and rear weatherstrip 23 is in liquid-tight contact with the upper end of the one side wall 32b, it is possible to prevent the infiltration of water from the housing side drain 32 into the attachment portion 25 side (molding gap C11). Since the second lower seal portion 29 is connected to a lower end of the attachment portion 25, it is possible to more simply bring the base end portion 29a into contact with the upper end of the one side wall 32b positioned lower than the attachment portion 25.

(3) In the embodiment, when the first seal portion 27 of the corner portion 24 is molded, it is possible to omit man-hours such as providing a cavity insert in the die, providing a hole for the insertion of the cavity insert in the second upper seal portion 28, or installing the cavity insert in the hole. Since it is possible to more simply install the die 80, it is possible to reduce the cost of components and the cost of the die.

(4) In the embodiment, since the attachment portion 25 is made of a solid material, for example, even if the second lower seal portion 29 is bent downward, it is possible to reduce an adverse effect on the attachment portion 25 or the seal portion 26 which forms a design surface.

(5) In the embodiment, since the first seal portion 27 and the attachment portion 25 collaboratively form a hollow cross-section, it is possible to more improve sealing performance between the panel end edges 12a and 13a. The following changes may be made to the embodiment.

In the embodiment, the base end portion 29a of the second lower seal portion 29 of the front and rear weatherstrip 23 may not be in liquid-tight contact with the upper end of the side wall 32b.

In the embodiment, instead of the second lower seal portion 29, or in addition to the second lower seal portion 29, one or multiple second lower seal portions may be formed in an area that is positioned higher than the second lower seal portion 29 and is interposed between the second upper seal portion 28 and the second lower seal portion 29. The second lower seal portions are preferably positioned lower than a lower end of the second upper seal portion 28 that is bent downward due to being in contact with the opening end edge 11a.

In the embodiment, if the second lower seal portion 29 extends further from the support portion 18 toward the opposite center side of the opening 11, the second lower seal portion 29 may not be in liquid-tight contact with the opening end edge 11a.

In the embodiment, the attachment portion 25 may extend over the entire circumference of the opening 11 along the circumferential edge portion of the opening 11. That is, the attachment portion 25 may have one continuous shape, and be common to both the side weatherstrips 22 and the like. Alternatively, the attachment portion 25 may be cut in the connection portion between the side weatherstrip 22 and the front and rear weatherstrip 23, and the side weatherstrip 22 and the front and rear weatherstrip 23 may be connected to each other via die-molding of the corner portion 24. In this case, the attachment portion 25 may be made of a sponge material such as synthetic rubber (for example, EPDM) or thermoplastic elastomer.

In the embodiment, the attachment portion 25 may be attached to the support portion (18 or 31) provided separately from the guide rail 14 and the like. In this case, if the support portion is positioned closer to the center side than the drain (rail side drain 19 or housing side drain 32), the support portion may be fixed to the guide rail 14 or the like, or may be fixed to the roof 10 without intervention of the guide rail 14 or the like.

In the embodiment, the weatherstrip 20 is attached to the roof 10 (both the guide rails 14 or the like) in a state where the weatherstrip 20 is engaged with the roof 10, that is, in a state where each of the support portions 18 and 31 is inserted between both the leg portions 25a and 25b. In contrast, the weatherstrip may be attached to the roof 10 in a state where the weatherstrip is engaged with the roof 10, that is, in a state where the attachment portion is fitted into a suitable fitting portion (support portion) that is provided along the circumferential edge portion of the opening 11 of the roof 10. Alternatively, the weatherstrip may be attached to the roof 10 in a state where the weatherstrip is engaged with the roof 10, that is, in a state where the attachment portion is interposed between suitable interposing portions (support portions) that are provided along the circumferential edge portion of the opening 11 of the roof 10.

In the embodiment, the roof panel may include one panel (a movable panel or a fixed panel), or may include three or more panels (movable panels or fixed panels) which are provided in a row in the forward and rearward direction.

A weatherstrip for a sunroof apparatus according to an aspect of this disclosure includes: an attachment portion that is attached to a support portion which is provided in a roof of a vehicle in such a way as to be aligned with a gap between an opening formed in the roof and a roof panel blocking the opening, and in which a drain is disposed closer to an opposite center side of the opening than the support portion; a first seal portion that is connected to the attachment portion, and is in liquid-tight contact with a panel end edge of the roof panel; a second upper seal portion that is connected to an upper end of the attachment portion in a cantilever manner, and is in liquid-tight contact with an opening end edge of the opening; and a second lower seal portion that is positioned lower than the second upper seal portion, is connected to the attachment portion in a cantilever manner, and extends further from the support portion toward the opposite center side of the opening.

According to this configuration, the first seal portion and the second upper seal portion are capable of collaboratively preventing the infiltration of water through the gap between the opening (opening end edge) and the roof panel (panel end edge) which blocks the opening. Particularly, since the second lower seal portion is positioned lower than the second upper seal portion, during high-pressure vehicle wash, if high-pressure water elastically deforms the second upper seal portion, and infiltrates into an area below the second upper seal portion, the high-pressure water elastically deforms the second lower seal portion as well. For this reason, downward force of high-pressure water is reduced, or downward force is dispersed in movement directions, Therefore, even if high-pressure water reaches the drain, it is possible to prevent the infiltration of water through the drain.

In the weatherstrip for a sunroof apparatus according to the aspect of this disclosure, it is preferable that one side wall of the drain is disposed lower than the attachment portion. Preferably, the second lower seal portion is connected to a lower end of the attachment portion, and a base end portion of the second lower seal portion is in liquid-tight contact with an upper end of the one side wall.

According to this configuration, since the base end portion of the second lower seal portion is in liquid-tight contact with the upper end of the one side wall, it is possible to prevent the infiltration of water from the drain into an attachment portion side. Since the second lower seal portion is connected to the lower end of the attachment portion, it is possible to more simply bring the base end portion into contact with the upper end of the one side wall positioned lower than the attachment portion.

In the weatherstrip for a sunroof apparatus according to this disclosure, it is preferable that the attachment portion includes a pair of leg portions which are respectively disposed on a center side and the opposite center side of the opening.

In the weatherstrip for a sunroof apparatus according to the aspect of this disclosure, it is preferable that the support portion includes a protrusion portion on at least one of the center side and the opposite center side of the opening, and the leg portions are engaged with the protrusion portion.

In the weatherstrip for a sunroof apparatus according to the aspect of this disclosure, it is preferable that the protrusion portion includes a first protrusion portion on the center side of the opening, and a second protrusion portion on the opposite center side of the opening, and the second lower seal portion extends on an extension line of a protrusion direction of the second protrusion portion.

According to the aspect of this disclosure, it is possible to prevent the infiltration of water.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A weatherstrip for a sunroof apparatus comprising:
an attachment portion that is attached to a support portion which is provided in a roof of a vehicle in such a way as to be aligned with a gap between an opening formed in the roof and a roof panel blocking the opening, and in which a drain is disposed closer to an opposite center side of the opening than the support portion;
a first seal portion that is connected to the attachment portion, and is in liquid-tight contact with a panel end edge of the roof panel;
a second upper seal portion that is connected to an upper end of the attachment portion in a cantilever manner, and is in liquid-tight contact with an opening end edge of the opening; and
a second lower seal portion that is positioned lower than the second upper seal portion, is connected to the attachment portion in a cantilever manner, and extends further from the support portion toward the opposite center side of the opening.

2. The weatherstrip for a sunroof apparatus according to claim 1,
wherein one side wall of the drain is disposed lower than the attachment portion, and
wherein the second lower seal portion is connected to a lower end of the attachment portion, and a base end portion of the second lower seal portion is in liquid-tight contact with an upper end of the one side wall.

3. The weatherstrip for a sunroof apparatus according to claim 1,
wherein the attachment portion includes a pair of leg portions which are respectively disposed on a center side and the opposite center side of the opening.

4. The weatherstrip for a sunroof apparatus according to claim 3,
wherein the support portion includes a protrusion portion on at least one of the center side and the opposite center side of the opening, and
wherein the leg portions are engaged with the protrusion portion.

5. The weatherstrip for a sunroof apparatus according to claim 4,
wherein the protrusion portion includes a first protrusion portion on the center side of the opening, and a second protrusion portion on the opposite center side of the opening, and
wherein the second lower seal portion extends on an extension line of a protrusion direction of the second protrusion portion.
